(19) United States
(12) Patent Application Publication
(10) Pub. No.: US 2002/0184368 A1
(43) Pub. Date: Dec. 5, 2002

(54) Network system, method and protocols for hierarchical service and content distribution via directory enabled network

(76) Inventor: Yunsen Wang, Saratoga, CA (US)

Correspondence Address: BACON & THOMAS, PLLC, 625 Slaters Lane, 4th Floor, Alexandria, VA, 22314-1176, US

(21) Appl. No.: 09/827,163

(22) Filed: Apr. 6, 2001

(51) Int. Cl. G06F 15/173

(52) U.S. Cl. 709/226; 709/224

(57) ABSTRACT

A network system is provided for management of hierarchical service and content distribution via a directory enabled network to improve performance of the content delivery network with a hierarchical service network infrastructure design. In accordance with the network system, a method and protocols are provided as to how to design the network of multiple data centers running existing Internet protocol and user's proprietary protocols, allowing a user to obtain various Internet services, especially the content delivery service, in a scalable and fault tolerant way. The network system is constructed into 4 layers, each layer is represented and managed by a service manager with back up mirrored managers. The layer 4 service manager is responsible for management of multiple CDN (content delivery network). The layer 3 service manager is responsible for management of one CDN network that has multiple data centers. The layer 2 service manager is responsible for management of one data center that has multiple server farms or service engine farms. The layer 1 service manager is responsible for all servers in a server farm. Each server of the server farm can be connected by LAN Ethernet Switch Network that supports the layer 2 multicast operations or by Infiniband switch which is the new industry I/O specification for server design.

### FIELD OF THE INVENTION

The present invention relates to a method and systems for exchanging service routing information, and more particularly, to a method and systems for management of hierarchical service and content distribution via directory enabled network by protocols to dramatically improve the content delivery network performance with a hierarchical service network infrastructure design.

### BACKGROUND OF THE INVENTION

Web has emerged as one of the most powerful and critical media for B2B (Business-to-Business). B2B(Business-to Consumer) and C2C(Consumer-to consumer) communication. Internet architecture was based on centralized servers delivering content or services to all points on the Internet Web traffic explosion has thus caused lots of Web server congestion and Internet traffic jam. According, a content delivery network is designed as a network that requires a number of co-operating, content-aware network devices that work one with another, in order to distribute content closer to users and locate the content at nearest location from subscriber upon request.

The Internet routine protocol such as BGP, is designed to exchange large Internet routes among routers. The BGP, an exterior routing protocol, is connection-oriented and running on top of TCP, and will maintain the neighbor connection through keep-alive messages and synchronize the consistent routing information throughout the life of connection. However, the BGP would not exchange information in this web server centric Internet. Therefore, it would be helpful to have a service (in LDAP directory format) routing protocol to exchange service information in a hierarchical way for service and content distribution management via a directory enabled network so as to improve the performance of the content delivery network and service provision and management.

### SUMMARY OF THE INVENTION

It is an object of the present invention to provide a novel network system having multiple levels for improving performance of the content delivery network via a hierarchical service network infrastructure design.

A further object of the present invention is to provide a method and protocols as to how to deliver quality content through flow advertisement from server hop by hop to client with crank back when next hop is not available. In accordance with the foregoing and other objectives, the present invention proposes a novel network system and the method thereof for management of hierarchical service and content distribution via a directory enabled network. The network system of the present invention comprises:

The server will exchange service information with the level 1 service manager by our proprietary protocols that have been filed for patent application too.

In order to manage such a scalable network, some concepts from Internet routing are utilized. The Internet routing protocol such as BGP is designed for the exchange of large Internet routes with its neighbors. The protocol will exchange the information among service managers in a hierarchical tree structure so as to help provide a better and scalable service provisioning and management. The information exchanged by this protocol is defined as the very generic directory information schema format that is formed as part of the popular industry standard of LDAP (light weight directory access protocol). The protocol is named as DGP (directory Gateway Protocol), which is a directory information routing protocol. Directory Gateway Protocol is similar to an exterior routing protocol BGP, except that the directory information is exchanged between DGP parent and child service manager. The BGP, on the other hand, exchanges IP route information with its neighbors. Similar to BGP, the Directory Gateway Protocol is connection oriented and running on top of TCP and will maintain the neighbor connection through keep-alive messages and synchronize the consistent directory information throughout the life of connection. In the load balance among multiple data centers, the method of Proximity calculation and data center's loading factor is proposed to be used by DNS to select the best data center as the DNS responses to the subscriber. In the LAN environment, in order to simultaneously update the information to the service devices and to improve performance, a reliable Multicast transport protocol is provided to satisfy this purpose. Running on top of this reliable Multicast transport protocol, a Reliable Multicast Directory Update Protocol is also provided in improve performance by mulicasting of directory information in a way similar to the standard LDAP operations. In order to manage this service network more efficiently, the Reliable Multicast Management Protocol is also provided to deliver management information to the service devices simultaneously to improve performance and reduce management operation cost. In order to push the content closer to the subscriber, the use of cache is helpful, but the cache content has to be maintained to be consistent with origin server. A cache invalidation method through the DGP propagation is invented to help maintain the cache freshness for this content delivery network. In order to manage the network more efficiently, the method of dynamic discovery of Service Engines, Level 1 Service manager and Level 2 Service Manager, is provided through the LAN multicast and link state routing protocol's opaque link state packet flooding with service information.

In order to support the content delivery which meets with quality requirement such as streaming media content, a method of delivering the content through flow advertisement from service engine hop by hop to client with crank back (crank back when next hop is not available) is provided to work with or without other standard LAN or IP traffic engineering related protocols.

### BRIEF DESCRIPTION OF THE DRAWINGS

The above and other objects and advantages of the invention will be apparent upon consideration of the following detailed description, taken in conjunction with the accompanying drawings, in which the reference characters refer to like parts throughout and in which:

FIG. 1 is a diagram illustrating Content Peering for Multiple CDN Networks in accordance with the system of the present invention;

FIG. 2a is a diagram illustrating an Integrated Service Network of Multiple Data Centers in accordance with the system of the present invention;

FIG. 2b is a diagram illustrating another Integrated Service Network of Multiple Data Centers in accordance with the system of the present invention;

FIG. 3 is a diagram illustrating Service Manager and Caching Proxy Server Farm in a Data Center in accordance with the system of the present invention;

FIG. 4 is a diagram illustrating Directory Information Multicast Update in Service Manager Farm in accordance with the system of the present invention;

FIG. 5 is a sequence diagram illustrating Reliable Multicast Transport Protocol Sequence in accordance with the method and system of the present invention;

FIG. 6 is a sequence diagram illustrating Transport Multicast abort operation sequence in accordance with the method and system of the present invention;

FIG. 7 is a sequence diagram illustrating Reliable Multicast Directory Update Protocol Sequence in accordance with the method and system of the present invention; and

FIG. 8 is a sequence diagram illustrating Reliable Multicast Management Protocol Sequence in accordance with the method and system of the present invention.

### DETAILED DESCRIPTION OF THE INVENTION

Layers of the Network System

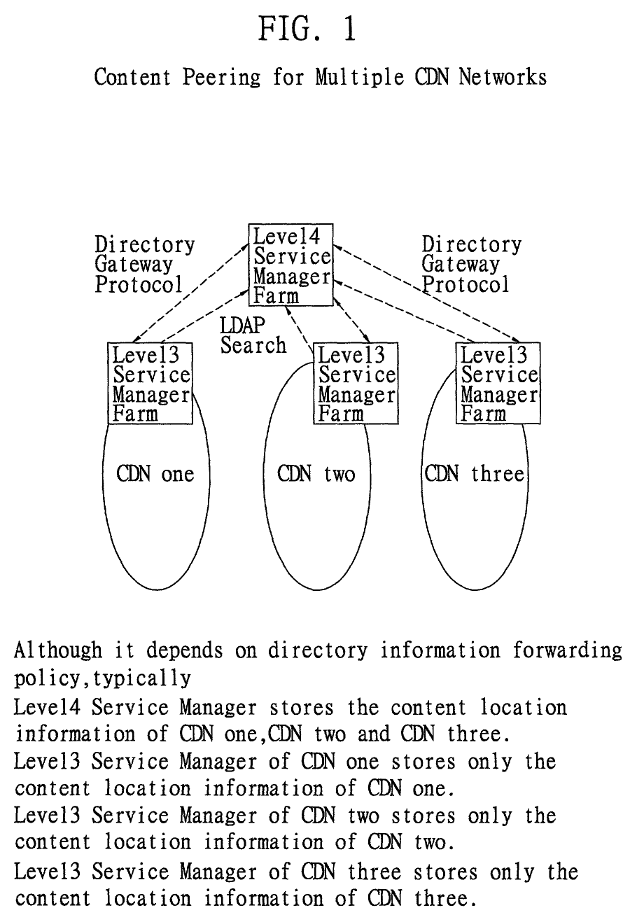

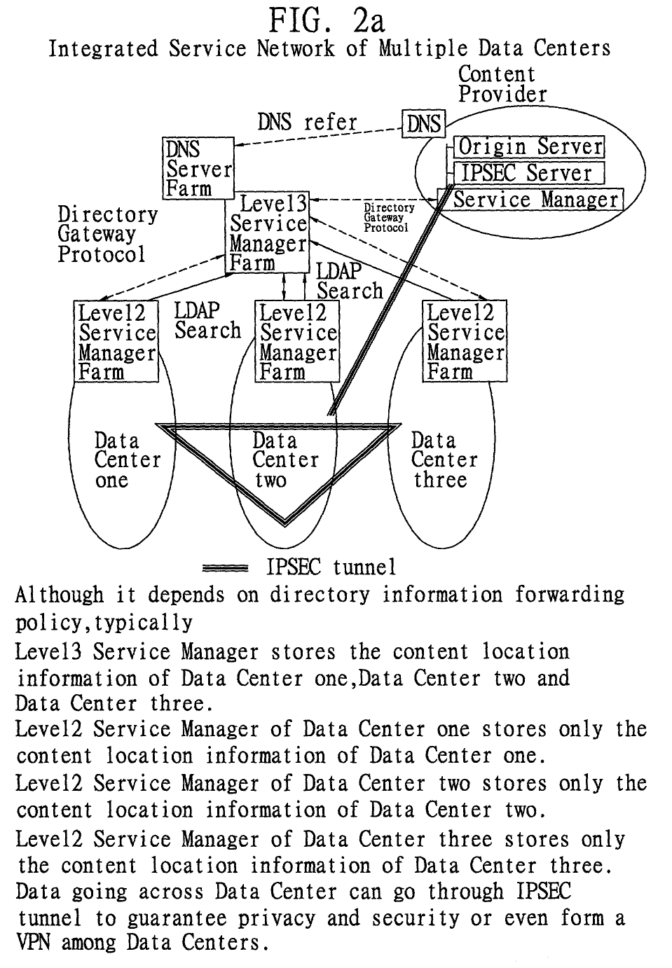

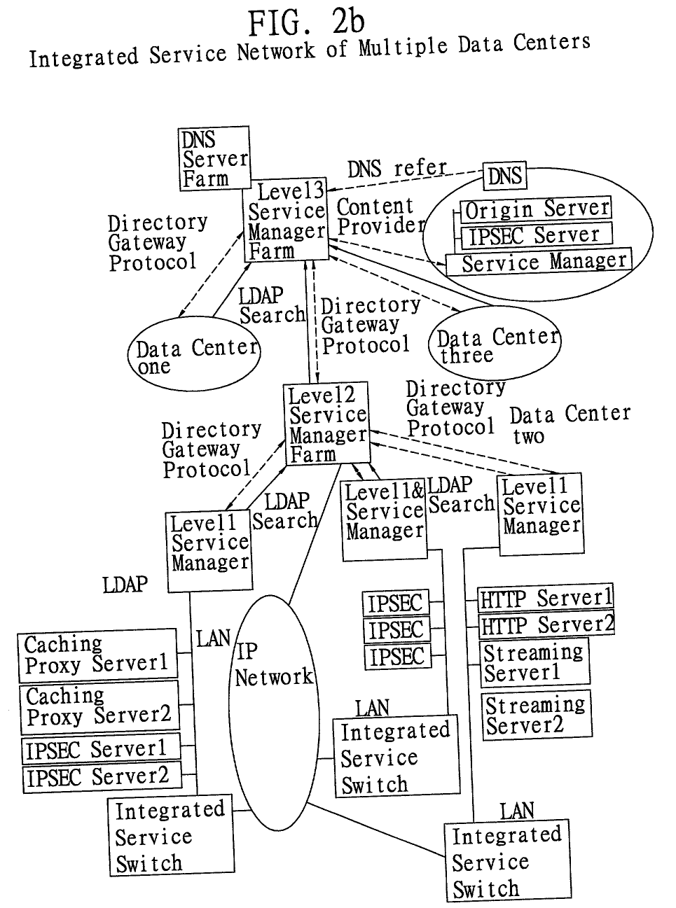

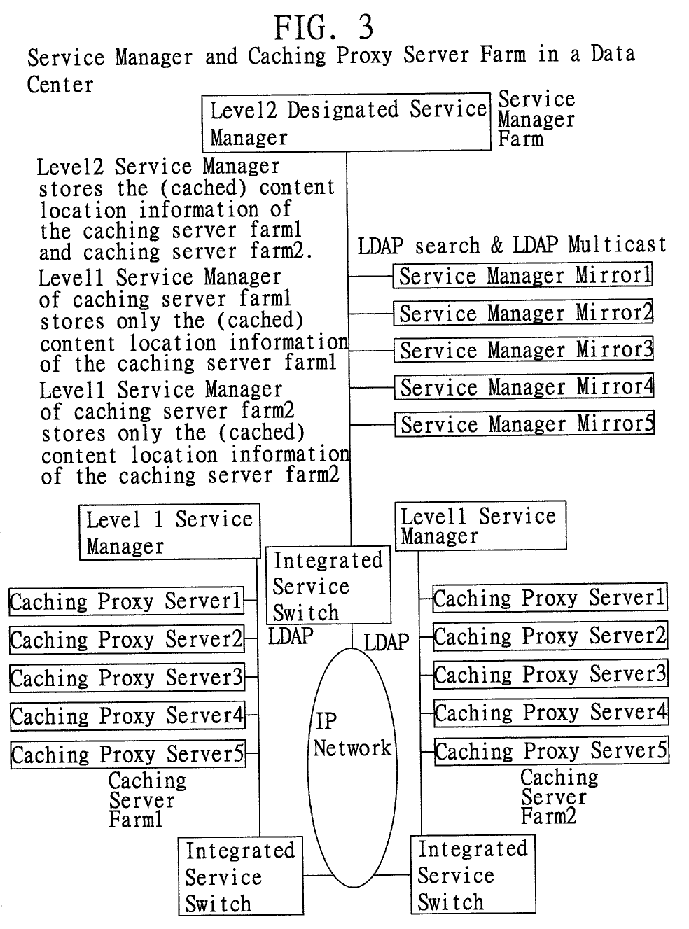

An embodiment of layers of the network system of the present invention is described with reference to FIG. 1, FIG. 2a, and FIG. 2b. FIG. 1 is a diagram illustrating Content Peering for Multiple CDN Networks in accordance with the system of the present invention. This hierarchical directory enabled network provides secure content distribution and also other services.

Services by this Network

Web and Streaming Content distribution service,

Web and Streaming content hosting service,

IPSEC VPN service,

Managed firewall service

And any other new IP services in the future.

Components of the Hierarchical Scalable Integrated Service Networks (HSISN)

a. Devices

Integrated Service Switch (ISS):

IP switch that forward IP traffic based on service and flow specification.

Service Engine(Server).

Service system (may come with special hardware) that process HTTP, cache, IPSEC, firewall or proxy etc.

Service Manager

A designated system running as management agent and also as LDAP server for LDAP search service and also running Directory Gateway Protocol with its parent Service Manager and child Service Manager to exchange directory information.

LDAP Schema:

Definition of the directory information, which are exchanged by service manager and searched by LDAP client.

SNMP MIB:

Definition of the management information, which are used between SNMP network manager and agent.

Protocols

Standard Protocols

Existing Routing protocol (OSPF, BGP) is run on ISS to interoperate with other router in this network.

Each server runs LDAP as a client; service manager also runs as LDAP server to serve the service engine LDAP search request.

Protocols invented

Service information protocol [patent pending in a separate application]

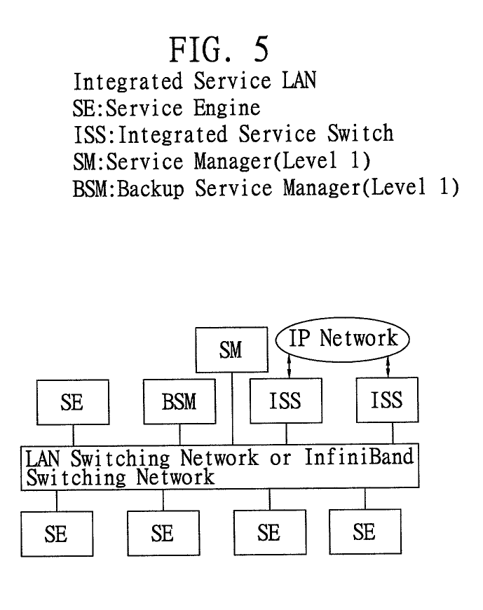

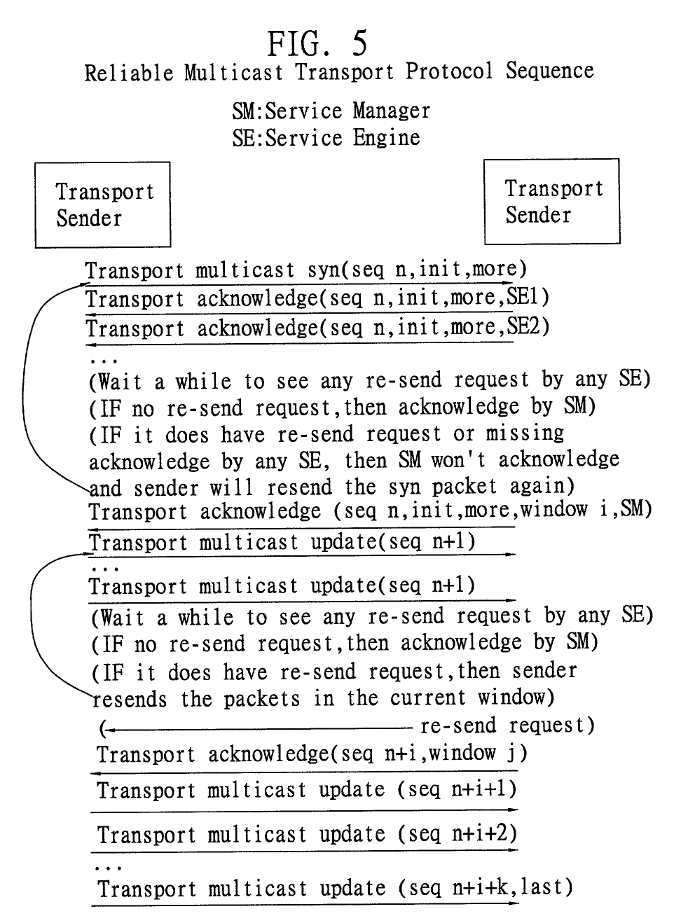

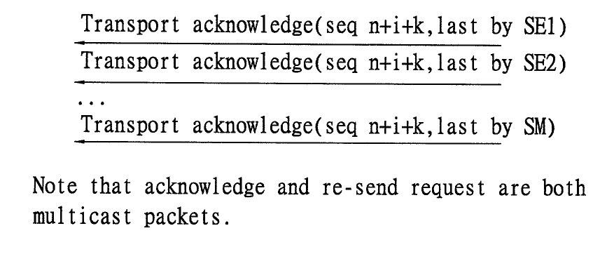

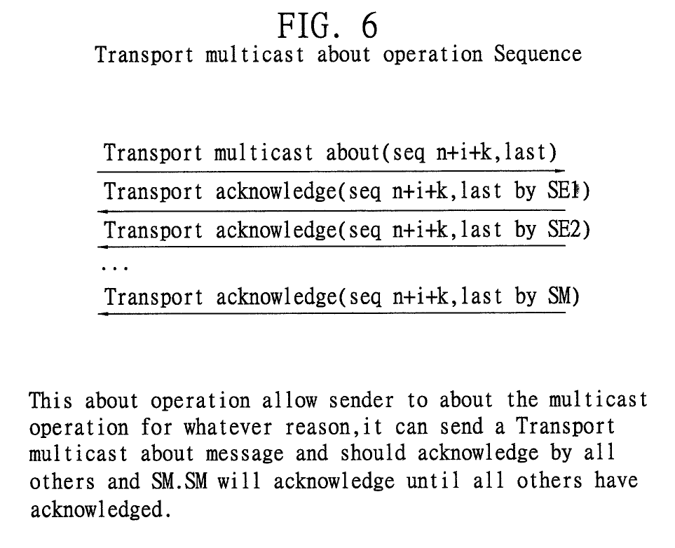

Referring to FIG. 5, it is run in a LAN or InfiniBand (a new I/O specification for servers) environment between ISS, service engines and level 1 Service manager to

1. register/de-register/update service and service attributes

2. service control advertisement—service engine congestion, redirect etc.

Unlimited service engines can be supported (extremely high salability with multiple boxes). Service control advertisement will dynamically load-balance among service engines because of ISS will forward messages based on these advertisement to available (less congested) service engine. Keep-alive message between ISS and service manager will help detect the faulty device, which ISS will be removed from its available service engine list.

Flow advertisement protocol [patent pending in a separate application]

Initiated by service engine to ISS (application driven flow or session)

1. Establish the flow in ISS to allow flow switching.

2. The flow comes with flow attributes; one of the attributes is the QoS,

Other flow attributes are also possible.

Flow attributes of QoS can enforce streaming content quality delivery requirement. The flow will map to outside network by ISS to existing or future standards such as MPLS, DiffServ, 802.1 p, Cable Modem SID.

Assigned Numbers Authority protocol [patent pending in a separate application]

It controls any kind of numbers needed to be globally assigned to this subnet or LAN or InfiniBand. Things like IP address pool, MPLS label range, global interface number, HTTP cookies etc. Designated service manager will be elected in each of the subnet (on behalf of service engine farm including ISS). The service type will be represented in a packet pattern matching way, so that different kinds of service engines can be mixed in the same subnet or LAN and all different kinds of service engines can be represented by the same service manager.

Directory Gateway Protocol (DGP)

Referring to FIG. 1 illustrating Content Peering for Multiple CDN Networks and FIG. 2a and FIG. 2b, which illustrates Integrated Service Network of Multiple Data Centers, Directory Gateway Protocol (DGP) is defined as a directory information routing protocol. Directory Gateway Protocol utilizes similar concepts from exterior routing protocol BGP, except that the directory information is exchanged between DGP parent and child instead of IP routes exchanged between BGP neighbors. Similar to BGP, the Directory Gateway Protocol is connection-oriented and running on top of TCP and will maintain the neighbor connection through keep-alive message and synchronize the consistent directory information during the life of connection. But the DGP connection is initiated from parent service manager to child service manager to avoid any connection conflict if both parent and child service manager try to initiate the DGP connection at the same time. To avoid any forwarding loop, the connection is not allowed between the same level service managers. It is only allowed between parent service manager and child service manager although it is possible to have multiple back up parent service managers connected to the same child service manager to provide the child service manager the LDAP search for redundancy reason.

Level 1 service manager (on behalf of one service subnet) will establish a DGP connection with its parent service manager(level 2 service manager). Usually the level 2 service manager will be running on behalf of the whole Data Center.

Level 2 service manager will also establish a DGP connection with its parent service manager (Level 3 service manager). Usually the service manager of an origin server farm will also establish a DGP connection with its parent service manager (Level 2 or Level 3 service manager)

Level 3 service manager usually runs as DNS server, which will direct user request to different data center as a geographical load balancing. The DNS redirection decision can be made based on the service loading attribute updated by the service data center through DGP incremental updates and other attributes such as proximity to subscriber.

The initial DGP connection will exchange the directory information based on each other's directory information forwarding policy, after the initial exchange, each service manager will only incrementally update (add or withdraw) its directory information service and service attributes, content and content attributes and etc. to the other side. One of the service attributes is the loading factor (response time) of the service domain that the service manager represents, and one of the content attributes is the content location including cached content location. The DGP packet types are OPEN, LDAP_ADD, LDAP_DELETE, LDAP_MODIFY_ADD, LDAP_MODIFY_REPLACE, LDAP_MODIFY_DELETE, NOTIFICATION and KEEP ALIVE.

Content change is treated as the content attribute (content time) change for that content, it will be propagated to the caching server that has the cached content (see Cached Content Invalidation Sequence section for detail). For frequently changed content, (like BGP) DGP supports directory information damping which will suppress the frequently changed directory information propagation. Similar to BGP, DGP also supports policy-based forwarding between its parent and children service managers. It is recommended to apply the aggregation policy to aggregate directory information before forwarding. Also similar to BGP, the TCP MD5 will be used for authentication.

Proximity calculation

As mentioned above, this is used with service loading attributes updated by each data center to make a DNS server direct a user's request to a best service data center as a geographical load balancing. Each IP destination (IP route, address and mask) will be assign with an (x, y) attribute, the x stands for longitude (between −180 to +180, but −180 and +180 is the same location because it earth is global) and y stands for latitude (between −90 to +90) on earth where the IP destination is physically located.

Assume that the subscriber's source address match as the longest prefix of an IP destination with (x1, y1) attribute and the Data Center's IP address prefix has the attribute of (x2, y2).

If the |x1−x2|<=180, the distance between the subscriber and data center is

((x1−x2)²+(y1−y2))^{2½}

If the |x1−x2|>180, then the distance between the subscriber and data center is

((360−(|x1−x2|))²+(y1−y2))^{2½}.

The (x, y) route attribute can be proposed to IETF as the extension of BGP route attribute.

Reliable Multicast Transport Protocol

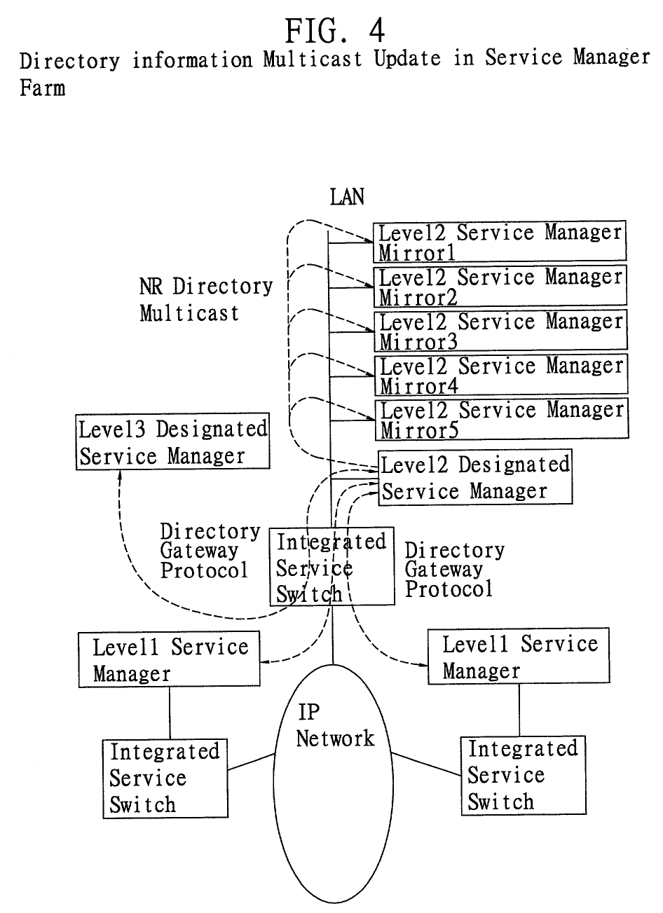

Referring to FIG. 4 Directory Information Multicast Update in Service Manager Farm and FIG. 5 Reliable Multicast Transport Protocol Sequence, in order to simultaneously update the information to the service devices in a multicast capable network and to improve performance, the reliable Multicast transport protocol is used to satisfy this purpose. It is similar to TCP, but with two-way (send and acknowledge handshake) instead of 3-way handshake is defined between sender and all the recipients to establish the connection. After that, the Service manager is responsible for specifying the window size (in packets) such that a sender can send message without acknowledgment. The window size is one of the service attributes registered by each service engine to the Service Manager. The Service Manager chooses the lowest value from the service attributes of the window size registered by each recipient. At the end of each window, the Service Manager is also responsible for acknowledging the receipt on behalf of all other recipients. It is recommended that the Service Manager should wait a small silent period (could be a configurable value) before sending the acknowledgment. The recipient should send a re-send request from the starting sequence number (for the window) if it detects any out of sequence packet reception or time out without receiving any packet in a configurable value. The sender can choose to resend from the specified re-send sequence number or terminate the connection and restart again. Unless the connection is terminated, the recipient will simply drop the packet that has been received. The last packet should acknowledge by all recipients not just Service Manager so as to indicate the normal termination of the connection. If the Service Manager detects that any recipient does not acknowledge the last packet within a time-out, it will request to re-send the last packet to that recipient (an unicast packet). If there are more than 3 re-sends which have been tried, the device will be declared as dead and will be removed from service engine list by Service Manager. If there is only one packet delivered, this protocol will become a reliable data gram protocol. Window size is defined as the outstanding packets without acknowledgement. Acknowledgement and re-send request are both multicast packets which allow the Service Manager to monitor.

Reliable Multicast Directory Update Protocol

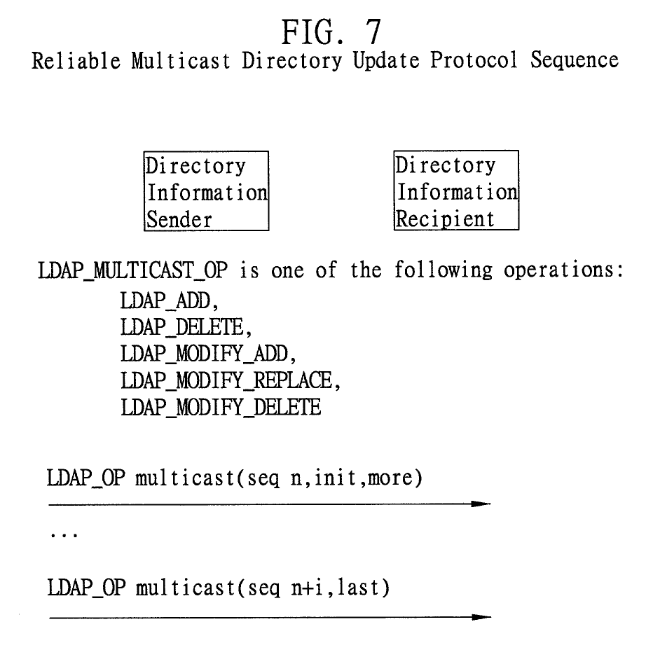

See FIG. 7, Reliable Multicast Directory Update Protocol is illustrated. It is running on Reliable Multicast Transport Protocol. The protocol is similar to LDAP run over TCP except that the transport layer is Reliable Multicast Transport Protocol.

Reliable Multicast Management Protocol

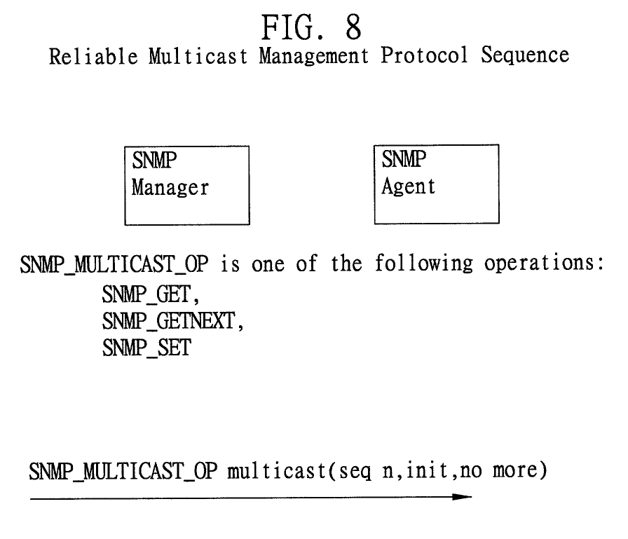

Referring to FIG. 8, Reliable Multicast Management Protocol Sequence is illustrated, the Reliable Multicast Management Protocol Sequence is running on Reliable Multicast Transport Protocol. Since there is only one packet to be delivered, this protocol will become a reliable multicast data gram protocol. The protocol is similar to SNMP run over Ethernet except that there is a transport layer to provided the multicast and reliability service.

Hierarchical Management information and Management method

The management agent is formed as a part of the Service Manager. For Policy-based Service Management, management information is defined in different level. Aggregation of management information is from one level to a next level. For example, the number of web page hit could have a counter for each cache service engine as well as a total counter for the whole level 1 service engine farms or the whole data centers.

For configuration management information, also define the configuration for different level. For example, a default router configuration is only for the same subnet, and DNS server could be for the whole Data Center. The Level 1 service manager is responsible for mulicasting default router configuration to the whole subnets while the Level 2 service manager sends the DNS server configuration to Level 1 service manager with indication of its Data Center level configuration. Then, the level 1 service manager needs to multicast its member in its subnet. Lower-level configuration or policy cannot conflict with high-level policy; if it the case, the higher-level policy should take precedence over the low-level one.

Directory schema and SNMP MIB

Several directory information schema and SNMP MIB need to be defined to support this Hierarchical Scalable Integrated Service Networks (HSISN).

Web Site object

Web Content object

Service Engine object

Integrated Service Switch object

User object

And other objects

Using the following URL as an example.

Web Site object (origin or cache site)

Origin Web Site

DN (Distinguished Name): http, vision, yahoo,com Attributes:

Service Site IP address:

Cached Service Site

DN (Distinguished Name): subject1, DataCenter2, CDN3 Attributes:

Service Site IP address:

New entry creation of Web Site object

Origin site will send DGP LDAP_ADD DN: http vision, yahoo com to Level 3 Service Manager (also at a DNS server) to add a new entry.

Entry modification of Web Site object

Based on the service level agreement, Level 3 Service Manager sends DGP LDAP_MODIFY_ADD web site object entry's attribute of Service Site Location. These IP addresses will add to the list of DNS entries of vision.yahoo.com.

The Yahoo's DNS server, which is responsible for the vision.yahoo.com, should refer the DNS request for vision yahoo.com to DNS in level 3 Service Manager. The DNS in level 3 Service Manager will reply with the IP address of service site that has lowest service metric, to the subscriber or based on other policies.

Cached Web Site Selection base on the best response from the cached web site to the subscriber

Example of one Yahoo web site with video based financial page:

Internet access provider's DNS server will refer to Yahoo's DNS server, and for vision.yahoo.com. Yahoo's DNS server will refer to Level 3 Service Manager of the content distribution service provider.

Each data center may have one or more service web sites, and each service web site may be served by a server farm with a virtual IP address. If there are multiple caching service sites of vision.yahoo.com available (ex. site one is 216.136.131.74, site two 216.136.131.99) and all assigned to serve vision.yahoo.com. The DNS in level 3 Service Manager will have multiple entries for vision.yahoo.com. It will select on of the sites as the DNS reply based on the policies (weighted round robin or service metric from these sites to the subscriber). Assume 216.136.131.74 is selected by the DNS as the response to the subscriber.

The subscriber sends http request as

Service metric

The Service metric from subscriber 1 to site 1 is the current average server service response time by site 1+weight*the current Proximity from subscriber 1 to site 1. The weight is configured based on policy. The site 1 calculates the current Proximity by the formula mentioned above. The site 1 of Level 1 Service Manager will receive the response time from each server in their keep-alive message by the service engine to calculate the current average service response time by servers as a loading factor of this site.

Web Content object (in either origin or cached site)

DN: fv.html, ie, web, http, vision, yahoo, com

Attributes:

Original Content Location: IP address of the origin server

Cached Content Location: DN of the cached service site 1, number of cached service engines that have this content in site 1, DN of the cached service site 2, number of cached service engines that have this content in site 2, DN of the cached service site 31, number of cached service engines that have this content in site 31, DN of the cached service site 41

Cached Content Service Engine MAC address in the Level 1 Service Manager:

Service engine 1 MAC (apply only to Level 1 Service Manager),

Service engine 2 MAC (apply only to Level 1 Service Manager),

Number of Caching service engines that have the cached content

Content last modified date and time:

Content expire date and time:

Service Engine object

DN: IP Address, Subnet 1, DataCenter2, CDN3

Attributes:

Service Type:

Service engine Name:

Service engine Subnet mask:

Service engine MAC addresses:

Service engine Security policy: use SSL if different Data Center

Service Manager ID address:

Service engine certificate:

Integrated Service Switch object

DN: ID address on server farm interface, Subnet1, DataCenter2, CDN3

Attributes:

Switch Type:

Switch IP address:

Switch MAC address:

Service Manager IP address:

Switch certificate.

User object

DN: name, organization, country

Attributes:

Postal Address:

Email address:

User certificate:

Accounting record.

New entry creation and modification of Web Content object

Based on the service agreement, origin site will send DGP LDAP_ADD DN: fv.html.ie.web.http.vision.yahoo.com to Level 3 Service Manager. After 216.136.131.74 is selected by the DNS as response, the subscriber sends http request as

The integrated service switch of this virtual IP address will direct the request to one of the less congested caching service engine based on another patent we invented, say caching engine one is selected. If the content is not in caching engine one, it sends LDAP search request to its level 1 Service Manager. If level 1 Service Manager doesn't have the content either, it refers to its level 2 Service Manager. If level 2 Service Manager doesn't have the content either, it refers to its level 3 Service Manager. The level 3 Service Manager will return the attributes of origin server IP address, indication of cacheable or not and other content attributes. It is not cacheable, caching engine one will http-redirect the subscriber to the origin server.

If it's cacheable content, the caching engine one will then initiate a new http session on behalf of the subscriber to the origin server. And it will cache the content if “cacheable” is also specified in the http response from the origin server. The redirect message is also supported by RTSP too, but may not always be supported by other existing application protocols. Once the content is cached, then it will LDAP_ADD object of DN: fv.html.ie.web.http.version.yahoo.com to Level 1 Service Manager. If object is not found in Level 1 Service Manager, then add DN: fv.html.ie.web.http.vision.yahoo.com with attribute of Cached Content Location of itself (DN of the service engine). If object is found in Level 1 Service Manager, then the object is to be modified to be added as new Cached Content Location attribute Level 1 Service Manager will then do DGP LDAP_ADD or DGP LDAP_MODIFY_ADD DN: fv.html.ie.web.http.vision.yahoo.com to Level 2 Service Manager. Level 2 Service Manager will then do DGP LDAP_ADD or DGP LDAP_MODIFY_ADD DN: fv.html.ie.web.http.vision.yahoo.com to Level 3 Service Manager.

The update of cache location directory information update is a triggered update operation that should be a lot faster than a periodical synchronization process used in existing replication process among LDAP servers.

Content retrieval from nearest location (origin or cached)

Retrieval from neighbor cache service engine is managed by the same level 1 Service Manager in the same LAN. If there is another subscriber sends http request as and the http request is forwarded by integrated service switch to service engine 2, which managed under same level 1 Service Manager (also as a LDAP Server) as service engine 1. When service engine 2, which doesn't have the content, LDAP_SEARCH from its level 1 Service Manager, which will return the attribute with service engine 1 as the content cached location.

Since it's cacheable content, the service engine 2 will then initiate a new http session on behalf of the subscriber to the service engine 1 instead of the origin server. And it will cache the content in addition to responding the content to its subscriber. Once the content is cached, service engine 2 will LDAP_ADD to the same level 1 Service Manager (also as LDAP Server) The entry should have existed, the service engine 2 will LDAP_MODIFY_ADD to add another cached location (itself) to the content attribute.

Retrieval from neighbor site is managed by the same level 2 Service Manager for the whole Data Center. If there is another subscriber who sends http request to second service site as and is forwarded to service engine 31 by the integrated service switch of the service site of 216.136.131.99. When service engine 31, which doesn't have the content, LDAP_SEARCH from its Level 1 Service Manager, which doesn't have the content either and then refer to Level 2 Service Manager, which will return the site of 216.136.131.74 as the cached location with attribute of the number of service engines that have the content. In case there are two or more sites that have the content, the site that has more service engines that have the content is to be chosen. Service engine 31 will then initiate a new http session on behalf of the subscriber to 216.136.131.74 instead of the origin server. And the service engine 31 will cache the content in addition to responding the content to its subscriber. Once the content is cached, service engine 31 will LDAP_ADD to its level 1 Service Manager (also as LDAP Server). The entry should not be found, level 1 Service Manager will add DN: fv.html.ie.web.http.vision.yahoo.com with attribute of Cached Content Location of itself (MAC address). And service engine 31's Level 1 Service Manager will also DGP LDAP_ADD DN: fv.html.ie.web.http.vision.yahoo.com to Level 2 Service Manager. The entry should be found, the level 2 Service Manager will modify to add another cached location (itself) to the content attribute and increment the number of sites that have the content.

Retrieval from neighbor Data Center is managed by the same Level 3 Service Manager for the whole CDN (Content Delivery Network). If there is the second service site of is located at another Data Center and if that Data Center doesn't have such cached content yet, the LDAP_SEARCH will eventually refer to Level 3 Service Manager to find the cached Data Center location. The http proxy will then be initiated on behalf of the subscriber from the caching service engine of one Data Center to its neighbor Data Center instead of the origin server, if the neighbor Data Center has the cached content. In case that multiple Data Centers have the cached content, the number of caching service engines (in that Data Center) that have the cached content determine the preference.

Service engine is able to dynamically discover its referral LDAP server, which is its level 1 Service Manager. The Level 1 Service Manager may or may not need a static configuration to find its Level 2 Service Manager, depending on whether or not the link state routing protocol (ex. OSPF) is running. If it is running, the opaque link state packet can be used to carry the service manager information and to be flooded to the routing domain. The LDAP search result could also be included by policy configuration. It is also possible to add policy management related attributes of that content such as proxy or redirect, cache life-time if cacheable etc.

Cached Content Invalidation

When the origin server modifies the content of DN: fv.html.ie.web.http.vision.yahoo.com, it will LDAP_MODIFY_DELETE to remove all the Cached Content Locations from Level 3 Service Manager. Alternatively, it can conduct a scheduled content update by specifying or change the expiration date attribute of the content through DGP. The level 3 Service Manager will LDAP_MODIFY_DELETE to remove all the Cached Content Locations or change expiration date from Level 2 Service Managers that it manges.

Add the Level 2 Service Manager will then LDAP_MODIFY_DELETE to remove all the Cached Content Locations or change expiration date from Level 1 Service Managers that it managers. And the Level 1 Service Manager will notify (multicast) all its caching service engines to remove that Cached Content from its storage.

When the content has been scheduled to be changed by the origin server, the origin server can also send LDAP_MODIFY_REPLACE to modify the content last modified date and time attribute in level 3 Service Manager and propagate downward to lower level Service Managers and caching service engines. Based on the last modified date and time, the server determines when to throw away the old content.

The dynamic discovery of among Service Engines (LDAP client), Level 1 Service Manager and Level 2 Service Manager

In a (layer 2) LAN environment, layer 2 multicast can be utilized to propagate the service information to level 1 Service Manager from all the service engines. A well-known Ethernet multicast address will be fined for Level 1 Service Managers (primary and back up Level 1 Service Manager).

At the link state routing domain, opaque-link-state-packet flooding will be used to propagate the service engine and services it provide in one are for one autonomous system by all the Level 1 Service Manager and Level 2 Service Manager.

Level 2 Service Managers should always flood to the whole autonomous system. If the whole autonomous system only have one Level 2 Service Manager, then opaque link state packets by Level 1 Service Manager should flood to the whole autonomous system. If each are has one Level 2 Service Manager, then opaque link state packet by the Level 1 Service Manager should flood to the area only. The Level 2 Service Manager can refer to other Level 2 Service Manager first before referring to Level 3 Service Manager for directory information, although the DGP connection to other same level Service Manager is not allowed.

Beyond one autonomous system, IP multicast may be utilized to propagate the service within the IP multicast tree to be among Level 2, level 3 or Level 4 Service managers. The static configuration can also be sued to propagate, search and update the service among Service managers.

Content delivery with quality (possible other policy too) through hop by hop flow advertisement from caching service engine to client with crank back

Hop by hop flow advertisement protocol for IP flow is specified based on pattern-matching rules. Flow advertisement will start from the caching service engine to its up-stream integrated service switch after the authentication accounting are checked or initiated, and the integrated service switch and hop by hop to the end user, if the flow advertisement protocol is supported. But the end user is not required to be involved in the flow advertisement protocol. In case the flow advertisement protocol is not supported, each hop will map the flow and flow attribute to its (could be different) upstream traffic characteristics through static configuration or signaling protocol. For example, the IP flow can map to ATM SVC or PVC, the ATM PVC or SVC can also map to IP flow through this hop-by-hop flow advertisement. If IP MPLS is also available, IP flow advertisement can map to MPLS through MPLS signaling protocol. If the upstream hop does not support any flow signaling, the flow advertisement would be stopped.

Flow switching requires every hop involved and should try to include all network devices from layer 2 to layer 7 switching devices as long as the flow can be mapped and defined. If only the class or traffic is defined, the down stream hop should still try to map to the appropriate traffic is defined, the down stream hop should still try to map to the appropriate traffic class on the upstream. The typical example of quality of service can map to whatever available on the up stream network such as DiffServ, Cable Modem's SID and 802.1 p.

In the case that the link or switch is down along the flow path, the upstream hop should terminate the flow by sending flow withdraw advertisement to its further upstream neighbor and propagate to the end user. On the other hand, the downstream hop should initiate another flow advertisement to the other available upstream hop and further propagate to the end user to re-establish the flow. If there is no upstream hop can accept the flow, the switch should terminate the flow, and advertise flow termination (crank back) to its downstream hop and its downstream hop should find anther available upstream hop so as to try to propagate to the end user again. If the upstream hop is not available again, advertise flow termination (crank back) to its downstream hop should continue until one available switch is found, or back to the service engine which will abort the flow.

VPN with PKI

VPN with PKI can sue the same directory enabled network, for non-content related service engine such as IPSEC engine. VPN and PKI can also refer to its Level 1 Service Manager to search the certificate and the like. And refer to Level 2 and 3 Service Managers for hierarchical user and accounting management.

What is claimed as:

1. A network system for management of hierarchical service and content distribution via directory enabled network, comprising:
at least one level 4 service manager responsible for management of multiple content delivery network;
at least one level 3 service manager responsible for management of one of the content delivery networks having multiple data centers;
at least one level 2 service manager responsible for management of one of the data centers having multiple server farms or service engine farms; and
at least one level 1 service manager for establishing a directory information routing protocol with the at least one level 2 service manager.

2. The network system of claim 1, wherein each server of the server farm is connected by LAN Ethernet Switch Network that supports a layer 2 multicast operations.

3. The network system of claim 1, wherein each server of the server farm is connected by the Infiniband switch.

4. The network system of claim 1, wherein data passing through the data center can go through an IPSEC tunnel to guarantee privacy and security, so as to even form a VPN among the data centers.

5. The network system of claim 1, wherein the at least one level 1 service manager is managed to establish a directory gateway protocol connection with at least one of the at least one level 2 service manager, the at least one level 2 service manager is managed to establish a directory gateway protocol connection with at least one of the at least one level 3 service manager, the at least one level 3 service manager is managed to run as a DNS server, which directs a user's request to a different data center as a geographical load balancing, and the service manager of the origin at server farm is also managed to establish a directory gateway protocol connection with the parent service manager thereof.

6. A network system for management of hierarchical service and content distribution via directory enabled network comprising:
at least one level 4 service manager responsible for management of multiple content delivery networks and storing content location information of the at least one content delivery network;
at least one level 3 service manager responsible for management of one of the content delivery networks having multiple data centers, wherein each of the at least one level 3 service manager stores the content location information of the corresponding content delivery network, and the content information of data centers;
at least one level 2 service manager responsible for management of one of the data center having multiple server farms or service engine farms, wherein each of the at least one level 2 service manager of the data center stores only the content location information of the corresponding data center; and
at least one level 1 service manager for establishing a directory information routing protocol with the at least one level 2 service manager, so as to manage each of the server farms, wherein the at least one level 1 service manager and the at least one level 2 service manager are created through a LAN multicast and a link state routing protocol's opaque link state packet flooding with service information.

7. The network system of claim 6, wherein each server of the server farm is connected by LAN Ethernet Switch Network that supports a layer 2 multicast operations.

8. The network of claim 6, wherein each server of the server farm is connected by the Infiniband switch.

9. The network of claim 6, wherein data passing through the data center can go through an IPSEC tunnel to guarantee privacy and security, so as to even form a VPN among the data centers.

10. The network of claim 6, wherein the at least one level 1 service manager is managed to establish a directory gateway protocol connection with at least one of the at least one level 2 service manager, the at least one level 2 service manager is managed to establish a directory gateway protocol connection with at least one of the at least one level 3 service manager, the at least one level 3 service manager is managed to run as a DNS server, which directs a user's request to a different data center as a geographical load balancing, and the service manager of the origin at server farm is also managed to established a directory gateway protocol connecting with the parent service manager thereof.

11. A method for management hierarchical service and content distributing via a directory enabled network including at least one level 4 service manager, at least one level 3 service manager, at least one level 2 service manager, and at least one level 1 service managers comprising the steps of:
managing at lest one content delivery network having multiple data centers and storing the content location information of the at least one content delivery network;
establishing a directory information routing protocol between the at least one level 1 service manager and the at least one level 2 service manager, and managing each of the server farms.

12. The method of claim 11, further comprising a step of establishing a directory gateway protocol connecting between the at least one level 2 service manager and at least one of the at least one level 3 service manager.
